(19) United States
(12) Patent Application Publication
(10) Pub. No.: US 2015/0329055 A1
(43) Pub. Date: Nov. 19, 2015

(54) Retractable entry system

(71) Applicant: Martin Richard Clanton, Goshen, IN (US)

(72) Inventor: Martin Richard Clanton, Goshen, IN (US)

(21) Appl. No.: 13/999,148

(22) Filed: Jan. 21, 2014

(51) Int. Cl. B60R 3/02

(52) U.S. Cl. CPC B60R 3/02

(57) ABSTRACT

A retractable entry system is provided which is powered to extend and retract along a plurality of spaced-apart rotatable axes, in sequential, reciprocating arcs of motion. With the first axis and in the first of the sequences of motion when retracting, a portion of the step assembly folds onto another portion of the step assembly, the steps being aligned tread to tread. With the second axis and in the second of the sequences of motion in retraction, the folded step assembly rotates from a horizontal to a vertical orientation against and into the supporting vehicle. The completed sequences of motion allow the retracted entry systems to fit between the outer side wall of a vehicle and the vehicle chassis.

### BACKGROUND AND SUMMARY OF THE INVENTION

The present invention relates generally to entry systems for vehicles and, more particularly, to recreational vehicles having retractable entry steps.

Vehicular entry systems typically include one or more steps leading up to a door if the vehicle has an interior floor significantly higher than the surface upon which the vehicle rests. In many applications, these steps extend laterally outward from the vehicle a significant distance in order to be most conveniently used by a person entering the vehicle. However, when the vehicle is in motion, such steps are preferably retracted toward the vehicle in order to minimize the road space or width needed by the vehicle, streamline vehicular motion, and avoid collision of the steps with objects near the path of the vehicle.

Retractable steps for vehicles are typically of two types, manually actuated or power actuated. Various different manual actuation systems have been used, including scissor linkages, parallelogram linkages, rotatable folding connections, and/or slide connections, to allow the steps to be shifted between opened and closed positions. In general, the user folds and unfolds these step systems when standing outside of the vehicle by grasping a portion of the step system, usually one or more of the steps themselves, and then pushing, pulling, or lifting the system as needed.

Power actuation is particularly advantageous when it is desirable to actuate the steps from inside the vehicle. Power actuation is also advantageous when the steps are subjected to ice, snow, mud and debris, such that users prefer to avoid contact with the steps other than with footwear. Further, power actuation also provides greater personal security when one or more persons are to be within the vehicle for an extended period of time because retraction of the step once the vehicle is occupied limits access to the vehicle interior by others. In addition, power actuation allows the steps to be easily positioned by a single person regardless of the weight or size of the steps. However, power actuation mechanisms tend to take up significantly more space than manual actuation systems even for the same size and number of steps because of the extra space required for the motors and/or other actuators which drive the steps.

In general, the space required by retractable entry systems of either type is first determined by the number of steps needed to reach from the door to within a comfortable distance from the ground (or to the ground itself, if that is desired). Then, the nature of the supporting structure for those steps must be taken into account, and then the “folding” or retracting structure (power actuated or not). Finally, consideration must be given for how the entry system is to be mounted to the vehicle.

For greatest strength and security, it can be advantageous to mount the retractable entry system directly or indirectly to the primary frame or chassis of the vehicle (often of I-beam or rectangular tube construction), rather than merely to the outer side wall of the vehicle. Thus, an opening is often left in the side wall to allow the retractable entry system to be bolted, for example, to the underlaying I-beam, typically 14 inches or so inwardly of the side wall. However, having only a 14 inch wide space for retracted stowage can significantly limit the vertical reach or capacity of a retractable entry system.

It is usually undesirable to allow any portion of the retractable entry system to protrude significantly beyond the outer side wall when the vehicle is moving. Thus, when retracted, the entire entry system must fit within that 14 inch width. However, using conventional actuation systems, the maximum number of steps which can be folded into a 14 inch wide space may be only three, especially if the actuation system is powered. Thus, if a standard eight to ten inch drop is permitted between each step, the maximum height which is comfortably serviceable by such prior systems is with vehicles having an entry door no more than 32 to 40 inches above the ground (and even less so if the bottom step is desired to be close to or resting just at ground level, so as to relieve any cantilever effect on the entry system as a whole).

When fully extended, some entry systems can be subject to a cantilever effect which gives a noticeable and potentially unsafe “bounce” when someone uses the bottom step(s). To overcome that effect, some prior entry systems have been constructed to “beef-up” the structure to increase rigidity, but that can make the cost and/or retracted dimensions of the entry system significantly higher. Resting on the ground is one cost effective way for an entry system to eliminate the cantilever effect, but at a cost of losing one step's worth of vertical capacity.

Unfortunately for many prior retractable entry systems, a current trend in vehicles, particularly fifth wheel travel trailers and similar recreational vehicles, is to make the interior floor of the vehicle higher so that additional storage space is available below the interior floor. This tends to cause the vehicle entry door to be raised such that a three step retractable entry system is not feasible or desirable, especially if it is power actuated. This is particularly true where entry doors are used in the upper deck portion of the fifth wheel travel trailer, since the interior floor of the upper deck is higher still.

In response to these new vehicle designs, prior retractable entry door systems would need to have a special cut-out in the I-beam frame in order to add another step or two, or be mounted below the I-Beam, thereby reducing the ground clearance of the vehicle. Alternatively, a portion of the interior floor could be lowered to make up the extra step or two, at a sacrifice to usable floor space and floor planing optimization of the vehicle interior. Other solutions could involve using a vehicle chassis with a greater span between the I-beam and the outer side wall (thereby increasing the width of space available to mount and retain the retractable entry system), perhaps relying upon additional “outriggers” for vehicle support laterally of the I-beam toward the outer side wall. However, such chassis constructions can have significant disadvantages in terms of cost, weight, and structural capacity.

Another important factor which limits the usefulness of some prior retractable entry systems for the new, higher entry door vehicle designs, is that fuel economy and towability concerns impose substantial constraints on the permissible component weights. Ideally, the increased vertical capacity of the retractable entry systems must be achieved without significant increases in the system weight. At the same time, system reliability in a rugged environment is another critical concern, particularly for recreational vehicles. Fifth wheel travel trailers are, for example, hauled up and down over a wide variety of roads and trails, paved and unpaved, subject to significant usage stresses over time. Retractable entry systems would hardly be of value if their design could not stand up to those stresses for long periods of time.

Accordingly, it is an object of the present invention to provide an improved retractable entry system, especially one that is suitable for use with vehicles. In particular, objects of the present invention include the provision of retractable entry systems which:
a. require a minimum of retracted space while significantly improving the system's vertical capacity,
b. avoid expensive manufacturing and maintenance costs,
c. facilitate mounting to the vehicle and avoid special chassis requirements,
d. are reliable in operation and provide an increased sense of security to the user, and
e. are readily adaptable to a wide variety of vehicle designs and requirements.

These and other objects of the present invention are attained in the provision of a retractable entry system for fifth wheel travel trailers wherein the storage width of the retracted system is limited not by the horizontal dimension of the storage space in the vehicle but, rather, by the vertical dimension of the storage space, thus becoming larger as the height of the interior floor increases. Specifically, the retractable entry system is powered to extend and retract along a plurality of spaced-apart rotatable axes, in sequential, reciprocating arcs of motion. With the first axis and in the first of the sequences of motion when retracting, a portion of the step assembly folds onto another portion of the step assembly. With the second axis and in the second of the sequences of motion in retraction, the folded step assembly rotates from a horizontal to a vertical orientation. The completed sequences of motion allow the retracted entry systems to fit between the outer side wall of a vehicle and the vehicle chassis. The present invention allows the entry system to include at least four steps down from the vehicle entry door and multiple, independent drive motors for powered actuation without decreasing vehicle ground clearance.

In a broader sense, the present invention applies multiple directions of motion in the retraction process, either sequentially or concurrently, such that an otherwise limiting dimension of the entry system (such as its width) can be manipulated into an orientation with respect to the vehicle that does not require an inconvenient storage space dimension within the vehicle. This invention is applicable with a variety of different retraction structures for entry systems, including accordion-fold (reciprocating arcs of motion, as shown further below), scissor arms, and parallelogram linkage formats. In each case, the structure supporting the steps is compacted and that compacted arrangement is then moved by rotation or otherwise to a more desirable storage orientation with respect to the vehicle. While manual actuation entry systems can employ the present invention with some advantages, power actuated entry systems can employ the present invention with particular advantages, since at least some of the additional spacial constraints, which would be caused by power drive motors and actuators, are alleviated.

Other objects, advantages, and novel features of the present invention will become readily apparent from the drawings and detailed description below.

### BRIEF DESCRIPTION OF THE DRAWINGS

FIG. 1 shows a front, left side perspective plant view of an exemplary fifth wheel travel trailer having an embodiment of the present invention therein, with the retractable entry system in a fully retracted position.

FIG. 2 shows an enlarged front, left side perspective view of a portion of an exemplary fifth wheel travel trailer having an embodiment of the present invention therein, with the retractable entry system in a fully extended position and with an adjacent travel trailer slide out room in an extended position.

FIG. 3 shows a top, front, right side perspective view of an exploded assembly of a preferred embodiment of the present invention (the “right” side being with respect to a head on view of the retractable entry assembly, rather than the vehicle as a whole).

FIG. 4 shows a top, front end view of the assembled embodiment of FIG. 3.

FIG. 5 shows a top, front, right side perspective view of the assembled embodiment of FIG. 3 with the retractable entry system in a fully extended position.

FIG. 6 shows a top, front, right side perspective view of the assembled embodiment of FIG. 3 with the retractable entry system in a partially retracted position in the first of the sequences of motion during retraction, a portion of the step assembly starting to fold onto another portion of the step assembly.

FIG. 7 shows a top, front, right side perspective view of the assembled embodiment of FIG. 3 with the retractable entry system in a partially retracted position in the first of the sequences of motion during retraction, a portion of the step assembly folded onto another portion of the step assembly.

FIG. 8 shows a right side “X-Ray” view of the assembled embodiment of FIG. 3 with the retractable entry system in the position shown in FIG. 7.

FIG. 9 shows a right side “X-Ray” view of the assembled embodiment of FIG. 3 with the retractable entry system in a partially retracted position in the second of the sequences of motion during retraction, where the folded step assembly is partially rotated toward the vertical, storage position.

FIG. 10 shows a right side “X-Ray” view of the assembled embodiment of FIG. 3 with the retractable entry systems in a fully retracted position.

### DETAILED DESCRIPTION OF PREFERRED EMBODIMENTS

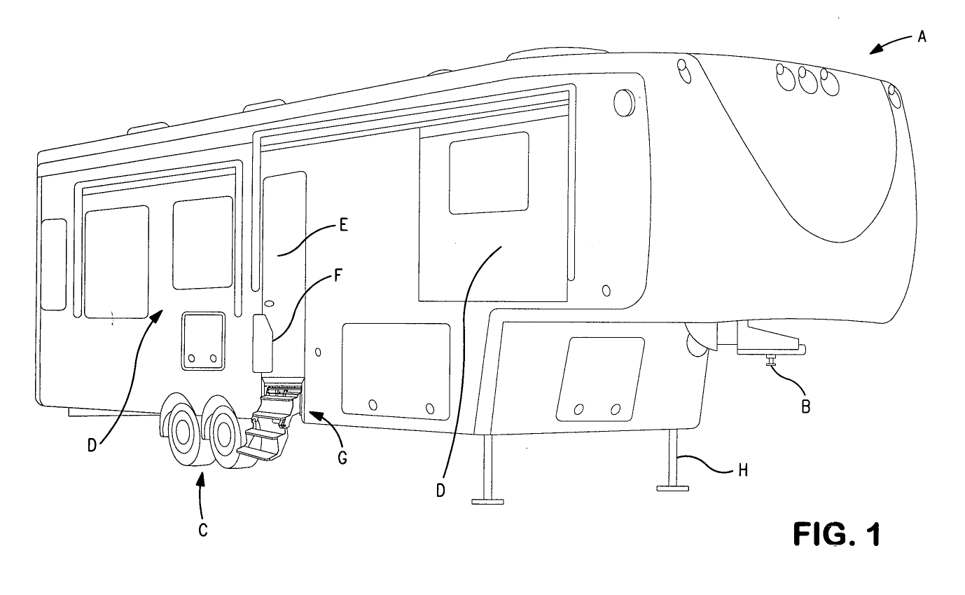

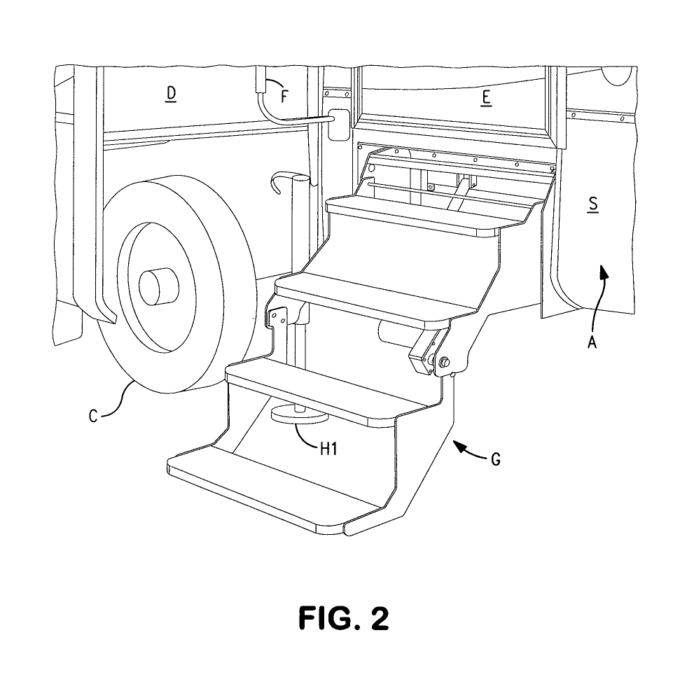

FIG. 1 shows and exemplary fifth wheel travel trailer A, having front hitch B, wheels C, fully retracted slide-out rooms D, and entry door E, folded door assist handle F, a retractable entry system G in a retracted and stowed position, and a stabilizing jack H lowered to the ground, as if readying for vehicle travel or if the vehicle had just stopped traveling. FIG. 2 shows and enlarged view of a portion of such a travel trailer A, with slide-out room D extended, door assist handle F unfolded, and retractable entry system G in an extended position to facilitate access to entry door E, with an additional stabilizing jack H1 lowered to the ground, as if the vehicle was park and ready for use of its interior. The following description is provided with respect to preferred embodiments of retractable entry system G.

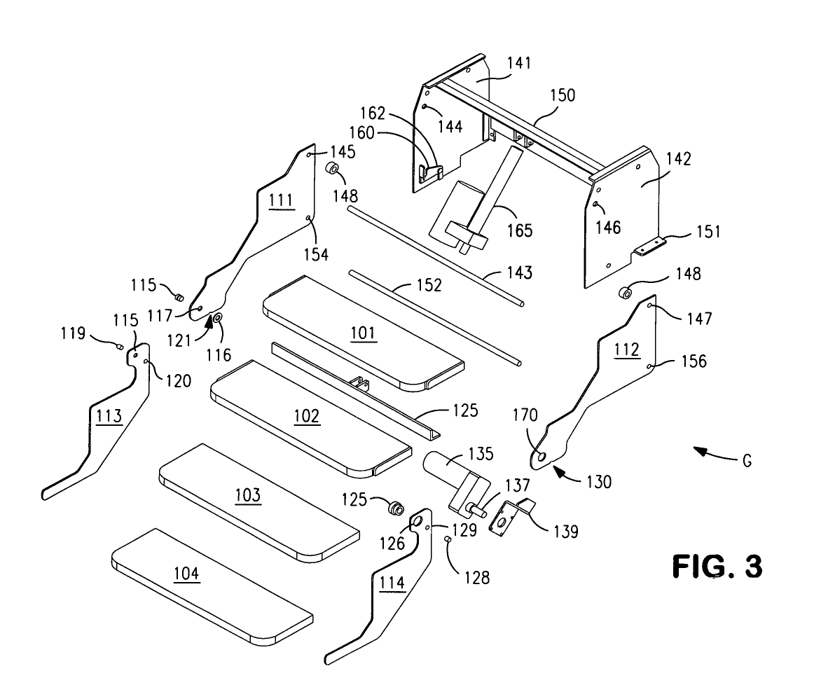

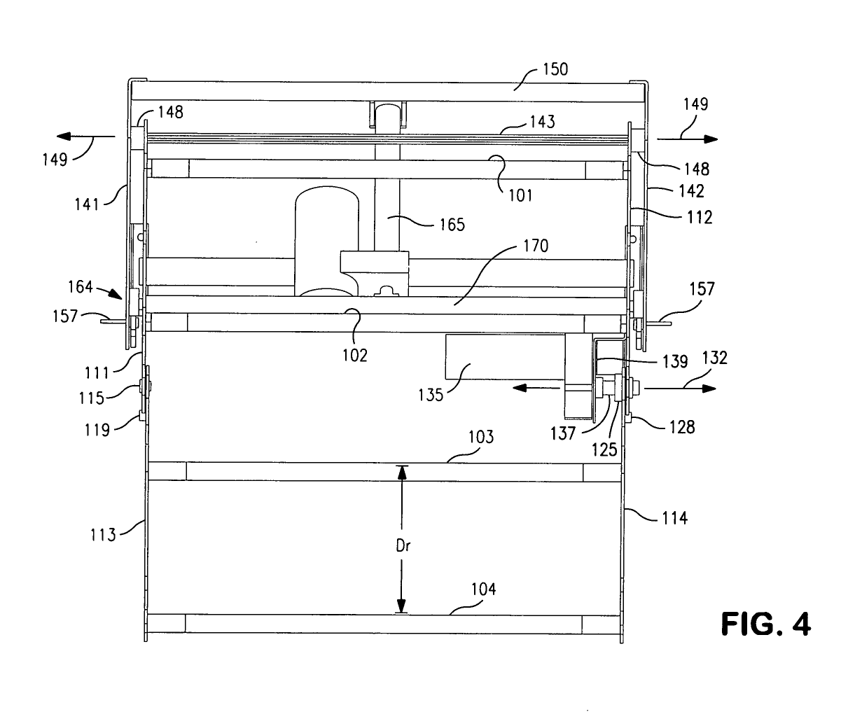

In general, entry system G is characterized by a plurality of steps, numbered 101-104 on the drawings. Typically, each step would be approximately eight increases wide, in the direction shown as “Ws” on step 101 in FIG. 3 (although in certain situations the present invention may allow the step width to be substantially increased). Typically, each step would be positioned within the entry system such that when the entry system is fully extended into the “down” position, as it is shown to be in FIG. 2, the vertical drop between the tread portion or tops of the steps would be eight to ten inches, in the direction shown as “Dr” between steps 103 and 104 in FIG. 4. In the example shown in the drawings, four steps are used. However, it should be understood that the present invention is readily adaptable to use with different numbers of steps, as may be desired in a given application.

FIG. 3 shows an exploded view of preferred embodiments of the present invention where the accordion fold motion of retraction is used. Steps 101-104 are framed at their ends by Parts 1-4, numbered also walls 111-114 in the drawings. Walls 111 and 112 are connected to steps 101 and 012 by any convenient conventional means, such as welding. Walls 113 and 114 are similarly connected to steps 103 and 104.

Walls 111 and 113 are, for example, rotatably connected by axle pin 115 through alignment of opening 117 in wall 111 and opening 118 in wall 113. One or more plastic washers 116 can be used in a conventional manner to assist in that connection. Stop pin 119, mounted through opening 120 in wall 113 is included to provide a predetermined stop against further rotation of wall 113 with respect to wall 111 when that pin engages notch 121 in wall 111.

Walls 112 and 114 are, for example, rotatably connected by drive bushing 125 through alignment of opening 126 in wall 114 and opening 127 in wall 112. Stop pin 128, mounted through opening 129 in wall 114 is included to provide a predetermined stop against further rotation of wall 114 with respect to wall 112 when that pin engages notch 130 in wall 112.

Drive bushing 125 is selectively rotated by motor 135, which can, for example, be a Klauber brand motor, such as part number K525. The controls for such a motor are located remotely from the entry system in any desired manner, including of conventional construction, and are not shown herein, suffice that when the motor is actuated, bushing 125 is rotated in one direction or another along axis of rotation 132, as desired for retraction or extension of the steps of the entry system, as describe further herein. Motor 135 includes a rotatable drive shaft 137 for engagement with drive bushing 125. Motor 135 is, for example, mounted to wall 112 via bracket 139, in a conventional manner, such as by welding of that bracket to the wall. Motor 135 can be replaced with another type of drive or actuation device in other applications, as desired for cost considerations and as is suited to the particular “folding” or compaction structure or motion used with the steps.

Wall 111 is rotatably connected to chassis side 141, and wall 112 is rotatably connected to chassis side 142. These connections are, for example, accomplished through passage of cylindrical rod 143 through opening 144 in side 141 and opening 145 in wall 111 at one end of rod 143, and through opening 146 in side 142 and opening 147 in wall 112 at the other end of rod 143. If desired, plastic washers 148 can be used to facilitate that connection of rod 143, as in a conventional manner. The connection of rod 143 between walls 111 and 112 and sides 141 and 142 is such that those walls are rotatable with respect to those sides about axis 149.

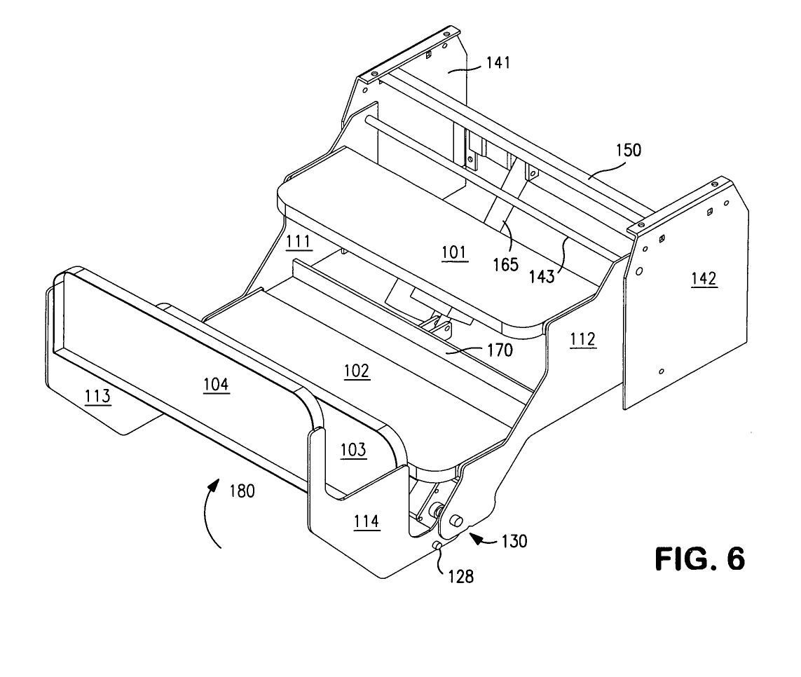

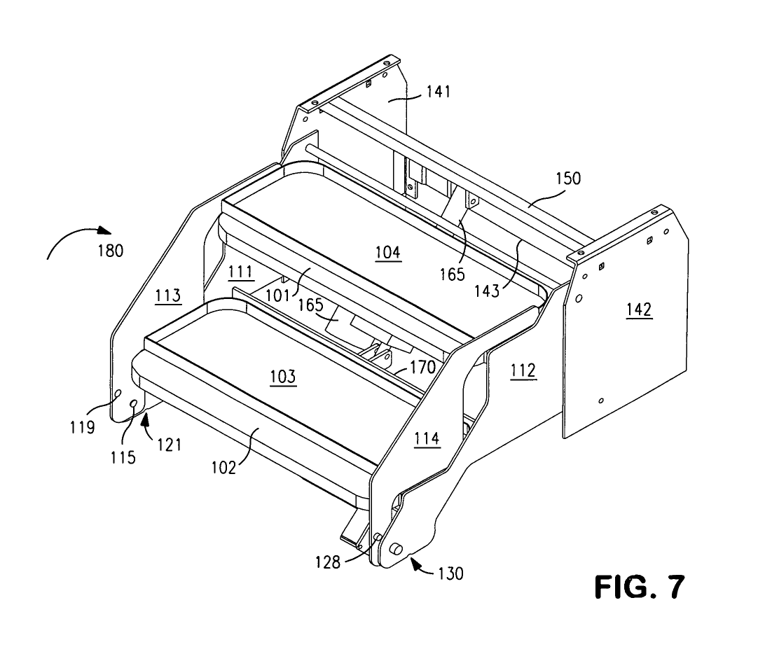

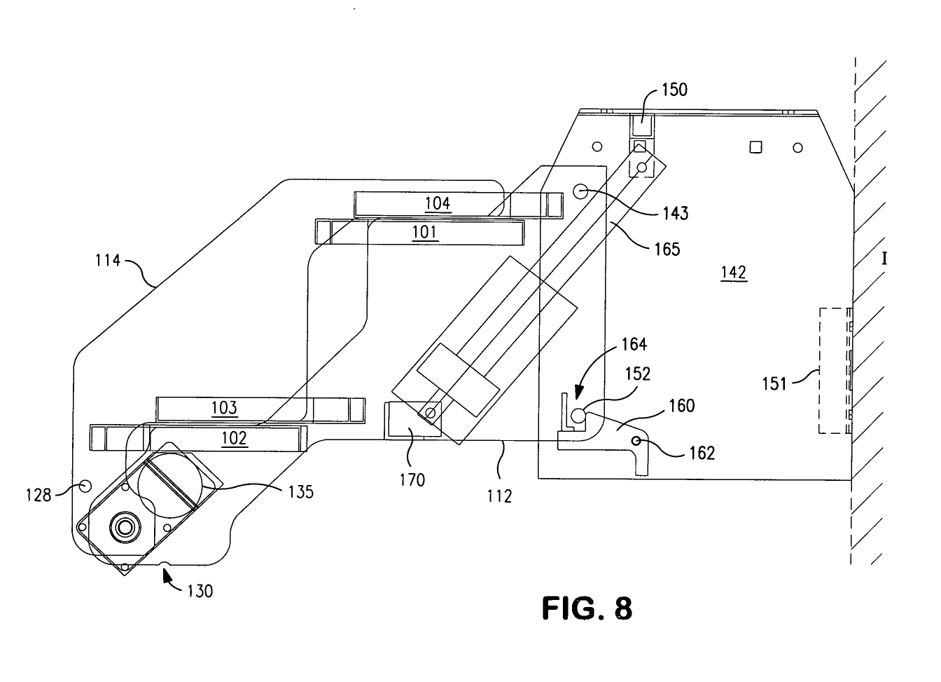

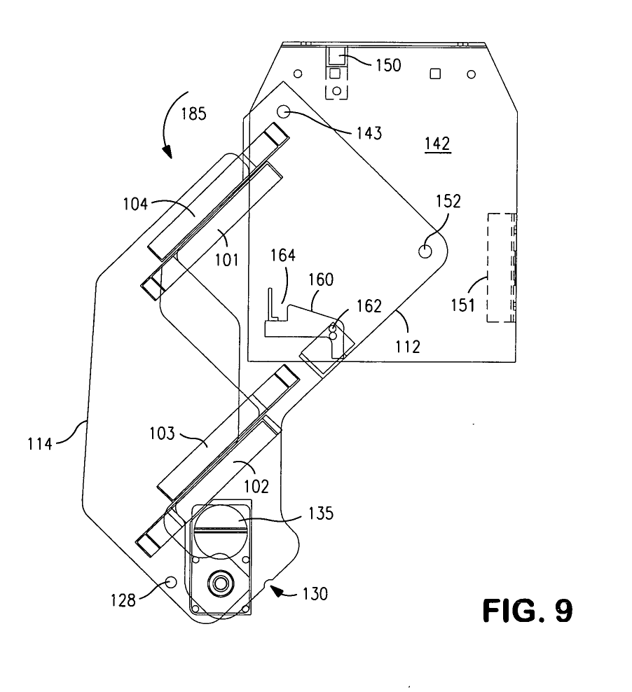

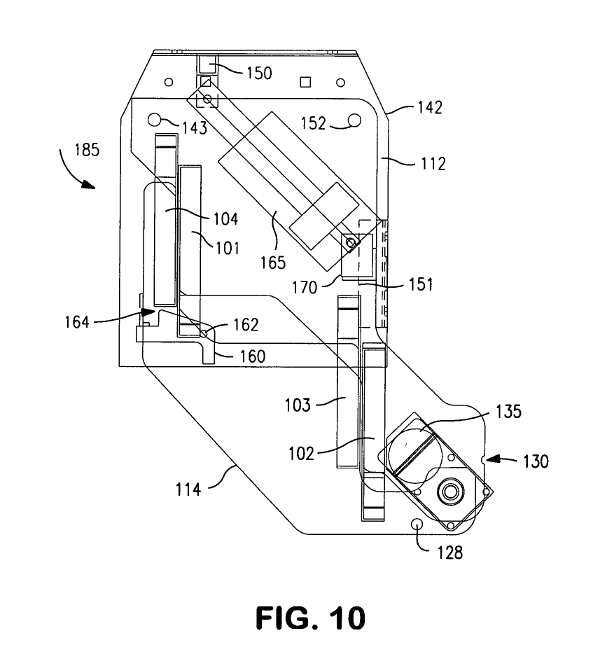

Sides 141 and 142 are, for example, joined and maintained in fixed relation to each other by top bracket 150. Sides 141 and 142 and/or bracket 150 can be mounted, in a conventional manner, to the supporting structure of vehicle A behind outer side wall S and adjacent the chassis of the vehicle, shown, for example, as I-beam I in FIG. 8. Sides 141 and 142 can be formed with flanges 151 to assist in mounting to vehicle A. As shown in FIGS. 6 and 7, those flanges 151 are optional, and as shown in FIGS. 8-10, flanges 151 can be formed at different positions.

Stop rod 152 is mounted at one end to wall 111 through opening 154 and at its other end to wall 112 through opening 156. Stop rod 152 serves to limit the rotation of walls 111 and 112 with respect to sides 141 and 142 and, preferably, permit walls 111 and 112 to be locked into position with respect to sides 141 and 142 at specified locations, such as when the entry system is in a fully extended position for use in facilitating entry to the vehicle. To assist in that regard, a pivotable spring lock 160 is mounted via spring lock pin 162 in side 141. Spring lock 160 is formed to include a portion 164 which can releasably receive and retain a portion of stop rod 152. Spring lock 160 can be selectively actuated by a variety of conventional means, as desired in a given application, including by manual levers, spring tensioned cables, electrical solenoids, etc. Thus, spring lock 160 can be actuated either or both at the point of pivot pin 162 or remotely, as from inside the vehicle.

In the embodiment shown in the drawings, for a power actuated entry system, a linear actuator drive member 165, for example, is connected between top bracket 150 and bottom bracket 170. One such actuator which can be suitable in certain applications is a commercially available PPD 1394 actuator. In other applications, various other drive members can be used and connected at the same or various other locations between the components of entry system G, such that wall members 111 and 112 are caused to move, rotatably about axis 149 or another suitably placed axis, for example, with respect sides 141 and 142. As with motor 135, drive member 165 can be replaced with another type of drive or actuation device in other applications, as desired for cost considerations and as is suited to the particular “folding” or compaction structure or motion used with the steps. Also, the controls for such a drive member are located remotely from the entry system in any desired manner, including of conventional construction, and are not shown herein, suffice that when the drive member is actuated, walls 111 and 112 are rotated in one direction or another along axis of rotation 149, as desired for retraction or extension of the entry system with respect to the vehicle, as describe further herein. Actuation of motor 135 and drive member 165 can be coordinated to operate sequentially by a push of a button from either the interior and/or exterior of the vehicle and/or from a hand-held remote control or the like. Electrical programming of such coordinated actuation can be by conventional or other means, as desired in a given embodiment. Similarly, the locking or releasing action of spring lock 160 can be automatically coordinated with respect to the actuation sequence of entry system G.

In certain applications of the present invention, the motor and drive member can, for example, have sufficient security and reliability that stop pins and/or a spring lock are not needed. In other applications, the use of stop pins and/or a spring lock can be used to relieve pressure on the motor and/or drive member. In manual applications of the present invention, the motor and drive member can be omitted. In certain applications, it may be possible to arrange a single motor or drive member to provide the desired motion for the entire entry system, but with multiple motors it may be possible to significantly reduce the torque and/or power requirements (and thereby lower the costs and/or increase the component useful life) for such a single motor or drive system. Further, the power source for motor 135 and linear actuator 165 can be from any source, electrical or hydraulic, for example, as desired in a given application.

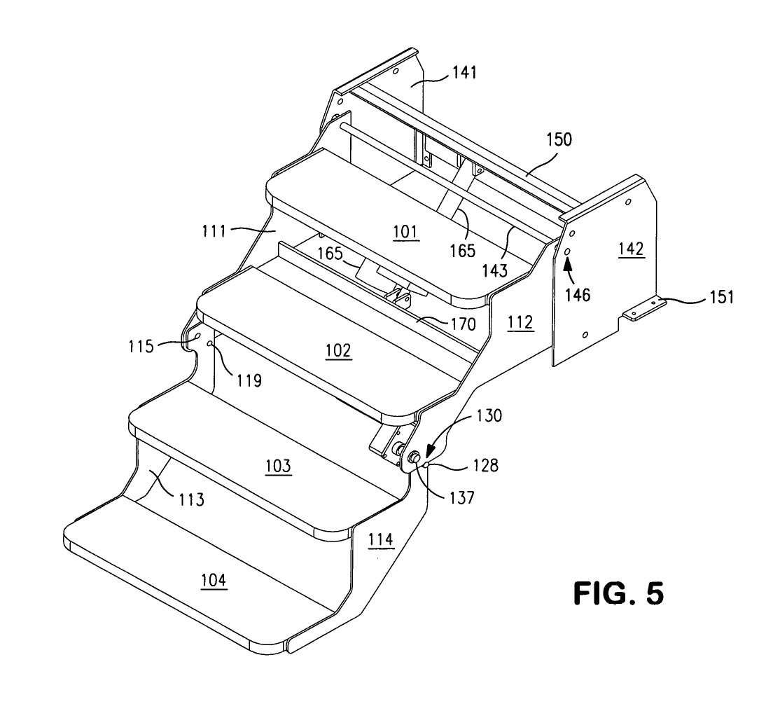

The operation of retraction of the entry system of the present invention is, for example, established in two phases or sequences of motion. In many applications, those sequences occur one after the other, at different times. However, in given applications it may be possible for both sequences to occur concurrently at the same time. In the first sequence of motion, the entry system moves from a fully extended position, such as shown in FIG. 5, through a closing position, shown in FIG. 6, with steps 103 and 104 rotating upwardly about axis 132 (clockwise, if viewed from the right side of entry system G) to a folded position, shown in FIGS. 7 and 8, having those steps lay face to face (or tread to tread) with steps 102 and 101, respectively, along arc 180. In the drawings, arc 180 is approximately 180 degrees of rotation from the extended position to the folded position.

In the second of the sequences of motion, the entry system moves from the folded position to the fully closed position, as shown in FIGS. 8-10. This is accomplished, for example, by rotating walls 111 and 112 downwardly about axis 149 (counterclockwise, if viewed from the right side of entry system G), along arc 185. In the drawings, arc 185 is approximately 90 degrees of rotation from the folded position to the closed position. At that closed point, the tread surfaces of steps 101-104 are now, preferably, nearly vertical. Any debris or ice which may have adhered to those tread surfaces has an increased tendency to fall off automatically, especially of the vehicle is in motion to a new location before the entry system is actuated to an extended position again.

In combination, these two sequences of motion follow reciprocating arcs, collapsing the step structure in two different directions or motions, an “accordion motion,” in effect. Thus, the necessary storage width of even the folded step structure is not just reduced, it is displaced from the horizontal plane to a more spacious plane, in this case the vertical plane (often made more spacious because of the raise interior floor of the vehicle). Therefore, the same vehicle design changes which require additional steps can be used to provide the additional storage space for those steps, without having to specially alter the vehicle chassis of interior floor space.

Moreover, spacial advantage is also provided by establishing the rotational axis 149 for walls 111 and 112 near the outermost edges of walls 111 and 112 and sides 141 and 142, as shown in the drawings, in effect cantilevering the step construction to a large extent both the walls and the sides. Thus, as the folded step assembly is rotated downward about axis 149, it is moved back into the space formed within sides 141 and 142, without significant interference or restriction from portions of the walls remaining there. Conversely, when the entry system is fully extended, less material is needed for walls 111 and 112 to provide the fullest step projection horizontally from the vehicle side wall, thus keeping component weight and cost lower.

Another way of looking at the present invention is that it has provided a simplified means for the horizontal width of the step structure to be compacted into nearly the total step drop dimension, “Dr,” of only half of its steps. The present application has been described and shown with respect to vehicles, namely travel trailers, but it is certainly also applicable to aircraft, marine vehicles, and static structures where a retractable step or entry system is needed but must contend with special storage envelope concerns. In such other applications, it may be advantageous for the usually sequences of motion to be reversed, even if they are not simultaneous, such that during retraction the folding of the steps upon each other occurs after the entry system is rotated toward the side wall of the item it is mounted to.

Accordingly, while the present invention has been described and shown herein with respect to certain particular embodiments, that was done by way of illustration and example only. Another example of an application for the present invention would be where the door opening is not elevated, but rather lowered with respect to the location where the user would start to access the door. Therefore, the spirit and scope of the present invention are intended to be limited only by the terms of the attached claims.

What is claimed is:

1. A entry system for facilitating access to a opening, comprising:
a plurality of steps,
means for retaining those steps in a fixed relation to each other when the steps are to be used,
means for moving those steps to a compacted relation to each other when the steps are not to be used, so as to reduce at least a given dimension of the entry system, and
means for reorientating the entry system such that the given dimension of the entry system can be positioned with respect to the opening with a more convenient spacial storage need.
